(19) United States
(12) Patent Application Publication
(10) Pub. No.: US 2007/0164617 A1
(43) Pub. Date: Jul. 19, 2007

(54) Symmetrical two phase motor with a bipolar permanent magnet rotor and method of making such a motor

(75) Inventors: Daho Taghezout, Morges (CH); Marc Vuillioment, Diesse (CH)

Correspondence Address: GRIFFIN & SZIPL, PC, SUITE PH-1, 2300 NINTH STREET, SOUTH, ARLINGTON, VA, 22204, US

(73) Assignee: MICROCOMPONENTS SA, Grenchen (CH)

(21) Appl. No.: 10/598,548

(22) PCT Filed: Mar. 7, 2005
(86) PCT No.: PCT/EP05/02385

§ 371 Date: Sep. 5, 2006

(30) Foreign Application Priority Data
Mar. 5, 2004 (EP) 04005345.6

(51) Int. Cl. H02K 5/00; H02K 37/14; H02K 1/00

(52) U.S. Cl. 310/49 R; 310/216; 310/254; 310/40 MM

(57) ABSTRACT

The two phase motor of small size is formed by a stator comprising principal magnetic poles (8, 10, 12) arranged in the same general plane and by a rotor provided with a bipolar permanent magnet (6). The first and second principal poles are connected to the third principal pole by two magnetic cores respectively, each carrying one of two windings (20, 22). The third principal pole (12) defines to adjacent secondary poles (26, 28) separated from one another by a region (30) of high magnetic reluctance. The first and second principal poles (8, 10) and the two secondary poles (26, 28) are distributed in four sectors of a circle of around 90° around the stator aperture (40). The invention also concerns a method of making the stator of a motor of the type described above.

This is a National Phase Application in the United States of International Patent Application PCT/EP 2005/002385 filed Mar. 7, 2005, which claims priority on European Patent Application No. 04005345.6, filed Mar. 5, 2004. The entire disclosures of the above patent applications are hereby incorporated by reference.

The present invention relates to a motor of small size provided in particular for driving the hands of an analog display device. More particularly, the invention concerns a motor of two phase type having a rotor equipped with a bipolar permanent magnet arranged in an aperture of the stator and having radial magnetic polarisation relative to the axis of rotation of the rotor. By way of example, the motor according to the invention can be used in a device for driving hands indicating the value of a measured physical magnitude, especially the time in the field of horology, the speed or the frequency. In particular, the motor of the present invention can advantageously be used to drive the hands of a counter arranged in an instrument panel of a vehicle.

The man skilled in the art knows of several two phase motors of small dimensions used to drive an analog display. In particular he knows of such a motor whose stator has three magnetic poles distributed in three respective sectors of a circle of 120° around the stator aperture. One of the three poles is common to the two main magnetic circuits of this motor. Such a motor can be of a relatively non complex construction and has a planar stator structure which is advantageous for integration in devices of small thickness, in particular in a watch movement. However, such a motor has the disadvantage of not being magnetically symmetrical, that is so say with coupling fluxes between the magnet of the rotor and each of the two windings which are in phase quadrature (about 90° out of phase). Thus, such a two phase motor exhibits in the region of the magnetic poles of the stator a structure appropriate to a three phase motor with a phase difference of about 120° between the magnet-winding coupling fluxes. In the context of such a two phase motor, the non symmetry of the coupling fluxes creates a high pulsing couple which limits the useful couple of the motor in the dynamic regime, increases the electrical consumption and creates vibrations of the motor.

The man skilled in the art also knows of symmetrical two phase motors having four magnetic poles coupled two by two to a winding. The two magnetic circuits of the motor are provided independently of one another, that is to say they are isolated magnetically. The machining and assembly of such motors are generally more complex than for the two phase motor with three magnetic poles described above. Moreover, the magnetic isolation of the two magnetic circuits of the stator which cross each other generally requires a construction with a stator having a greater thickness or height; this is in particular to allow the formation of an air gap between the region of superposition of the two magnetic circuits.

The object of the present invention is to provide a two phase motor of symmetrical type with a planar stator structure, small space requirement and high performance, with a reduced cost of manufacture.

To this end the present invention provides a two phase motor of small dimensions formed from a stator carrying two power supply windings and a rotor equipped with a bipolar permanent magnet, the stator defining first, second and third principal magnetic poles which together define a stator aperture in which the bipolar magnet of the rotor is housed. The first and second principal poles are connected to the third principal pole by two respective magnetic cores, each carrying one of the two windings. This motor is characterized in that the third principal magnetic pole defines two adjacent secondary poles, separated by a region of high magnetic reluctance in the peripheral region of the stator aperture. The first and second principal poles and the said two secondary poles are distributed in four sectors of a circle of about 90° around the stator aperture.

According to a particular feature of the invention, the region of high magnetic reluctance separating the two secondary poles is defined by a non-through slot which opens into the stator aperture. This relatively long slot thus penetrates into the third principal pole without dividing it into two. The slot is thus blind.

The stator is preferably formed from an iron-silicon alloy.

Another object of the invention is to provide a method of making the abovementioned motor.

To this end the invention also provides a method of making a motor of small dimensions as defined in claim 6.

The present invention will be explained in more detail with the aid of the following description, given with reference to the accompanying drawings, given by way of non-limiting example, in which:

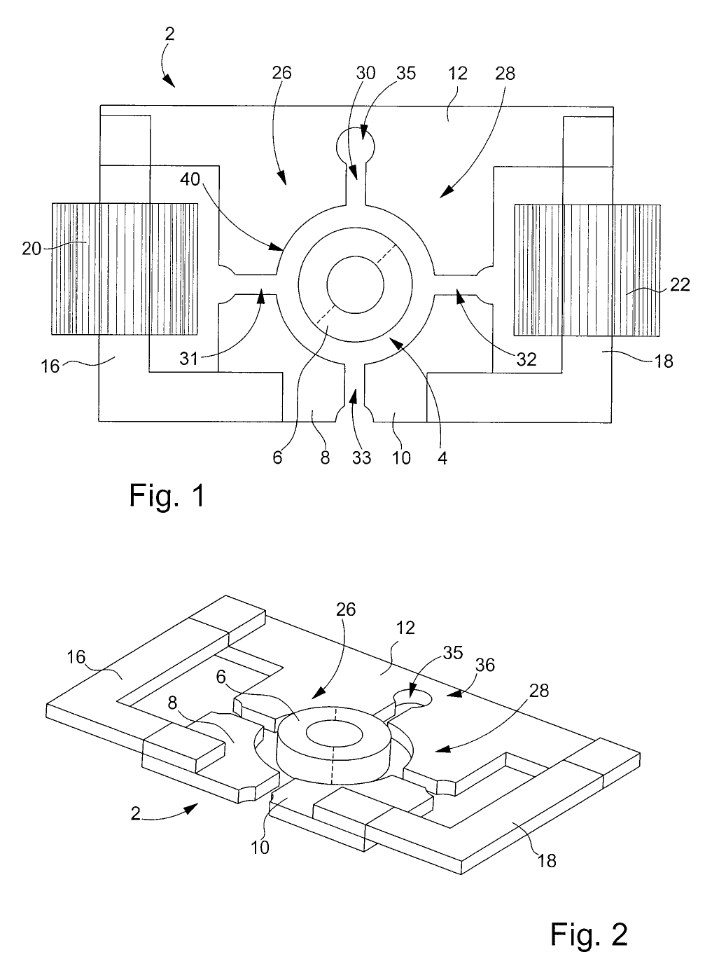

FIG. 1 is a perspective view of the stator and the permanent magnet of the rotor of a first embodiment of the motor according to the invention;

FIG. 2 is a view from above of the motor of FIG. 1;

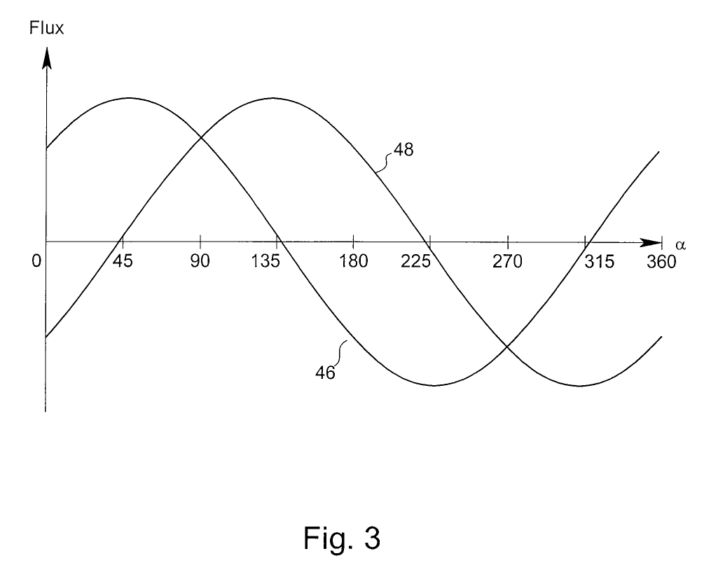

FIG. 3 shows graphically the magnet-winding coupling flux for each of the two windings of the first embodiment as a function of the angular position of the rotor;

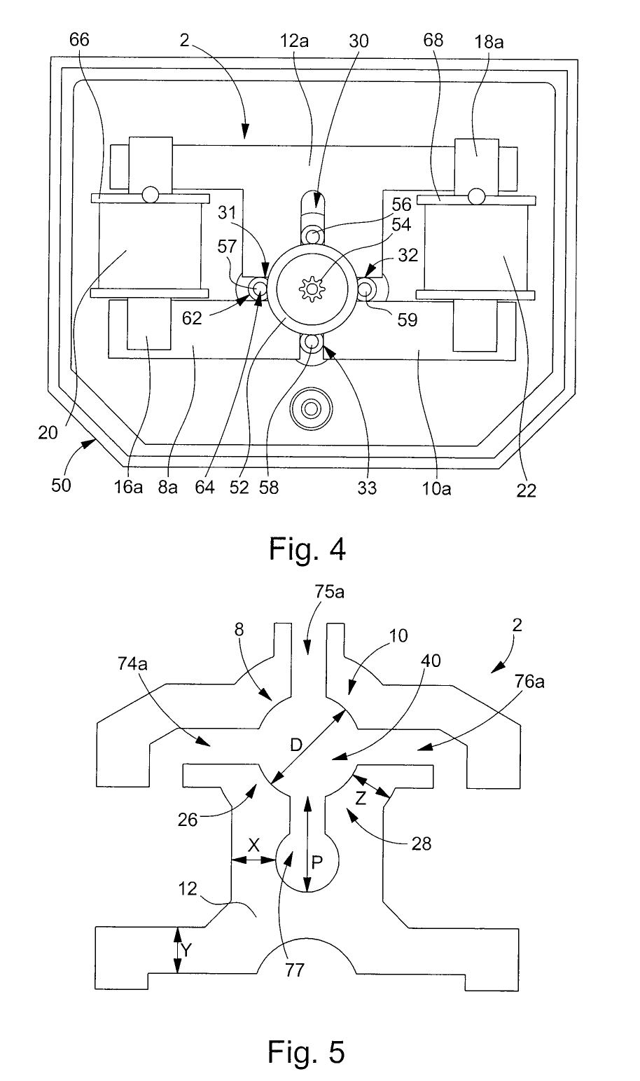

FIG. 4 is a view from above of a second embodiment of the motor according to the invention;

FIG. 5 shows the stator of a second embodiment of the motor according to the invention, and

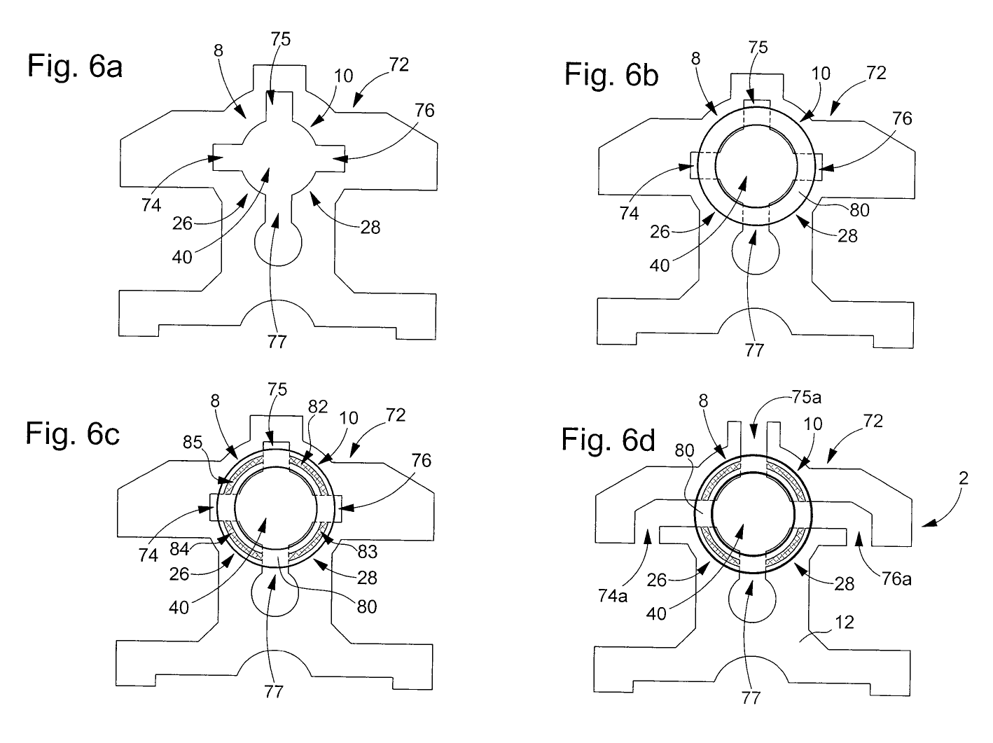

FIGS. 6a to 6d describe the steps of the method according to the present invention of making a motor according to the second embodiment.

The motor according to the first embodiment comprises a stator 2 and a rotor 4 equipped with a bipolar permanent magnet 6 of annular form and with radial magnetisation. The stator 2 is formed by three principal magnetic poles 8, 10 and 12. The first and second principal poles 8 and 10 are connected to the third principal pole 12 by two magnetic cores 16 and 18 respectively, having the general form of an L. The three principal magnetic poles define a stator aperture 40 in which the permanent magnet 6 is housed. The cores 16 and 18 carry two power supply windings 20 and 22 respectively. The third principal pole defines two secondary magnetic poles 26 and 28, these two secondary poles being adjacent and partially defining the stator aperture 40. The two secondary poles 26 and 28 are separated by a region 30 of high reluctance defining an air gap between the two secondary poles in the peripheral region of the stator aperture. It is noted that the air gap 30 is formed by a blind slot opening into the aperture 40. The slot 30 thus does not extend through and is so dimensioned that the two secondary magnetic poles 26 and 28 are connected magnetically by the external part 36 of the pole 12. This external part is characterized by a high magnetic permeability.

What is notable in the arrangement of the motor according to the invention is that a symmetrical two phase motor is obtained with principal magnetic circuits which are not isolated magnetically from one another. This result stems from the arrangement of the two principal poles 8 and 10 and the two secondary poles 26 and 28 and from the fact that the permanent magnet is bipolar. Thus, according to the invention, the first and second principal poles 8 and 10 and the two secondary poles 26 and 28 are distributed in four sectors of a circle of about 90° around the stator aperture, that is to say relative to the geometrical axis of rotation of the rotor 4. Thus, each of these four poles has a pole piece angularly offset by about 90° relative to the adjacent poles. The secondary poles 26 and 28 are separated from the two principal poles 8 and 10 by two air gaps 31 and 32 respectively defining two through slots. The two principal poles 8 and 10 are separated by an air gap 33 defining a third through slot. It is noted that the slots 31, 32 and 33 have recesses in their external parts serving for assembly and positioning of the stator parts. Likewise the slot 30 is terminated by a circular hole 35 provided for the passage of a pin for positioning the stator arranged in a seat provided to receive the motor according to the invention.

The magnet-winding coupling flux for each of the two windings 20 and 22 is shown in FIG. 3. The two curves 46 and 48 are obtained by simulation for the two windings 20 and 22 respectively with a phase difference of about 90°. Thus the structure of the stator poles and the use of a bipolar magnet with radial magnetisation gives the motor of the invention a quasi-symmetrical behaviour.

It is noted that the stator is preferably realised in Fe—Si in the described embodiment. However, in another embodiment an Fe—Ni alloy can be provided, allowing the slots 32, 32 and 33 to be replaced by high magnetic reluctance isthmuses without affecting the performance of the motor too much. This latter realisation has the advantage of physically connecting the stator poles and thus of ensuring better circularity of the aperture 40.

FIG. 4 shows a second embodiment of the invention schematically. This second variant is distinguished in particular by the fact that the various stator parts have simple shapes which are easy to machine or form.

The principal poles 8A and 10A of the stator 2 have a generally rectangular form, with a recess at a corner having a concave circular profile, to define the aperture in which the rotor is arranged. The rotor is mounted in a case 52 having a hole for passage of its spindle, this spindle carrying a pinion 54 of gearing outside the case.

The third principal pole 12A is distinguished from the first variant by the fact that the slot 30 has constant width corresponding to the diameter of positioning stud 56 for this third pole 12A. The motor is arranged on a support 50 having four positioning studs 56, 57, 58 and 59. These studs have a base 62 with a first diameter and an upper part 64 having a second diameter smaller than the first diameter. The base 62 serves to position the stator parts while the upper part 64 serves to centre the case 52 of the rotor.

The cores 16A and 18A have a rectangular shape. It is noted that they can be assembled with the other stator parts by screws or other known fixing elements, by laser welding, by bonding with a material having a good magnetic permeability or simply be held in place by parts of a case arranged to receive the motor of the invention. Such a case is for example formed by the support 50 and a cover (not shown) having parts in abutment with the cores.

It is noted that the case of the motor can comprise other studs or other positioning means for the various parts of the motor.

It is also noted that, in the second embodiment, the windings 20 and 22 are wound on respective formers 66 and 68. These formers can in particular serve for the arrangement of electrical contacts for supplying the windings.

The stator 2 of a second embodiment of a motor according to the invention is shown in FIG. 5. This motor is formed from three parts defining three principal magnetic poles 8, 10 and 12. The pole 12 defines two secondary poles 26 and 28 separated by a slot 77 terminating in a circular recess. The poles 8, 10 and 12 are magnetically separated from one another by slots 74a, 75a and 76a. The aperture 40 provided for the permanent magnet of the rotor has a diameter D. The slot 77 separating the two secondary poles 26 and 28 is blind and has a depth P. This depth P is slightly less than the diameter D. It is thus noted that the slot 77 has a relatively large depth P, this dimension being here of the same order of magnitude as that of the diameter D of the aperture 40. The two winding cores have not been shown in FIG. 5 but their arrangement is similar to that of FIG. 4. The stator 2 is machined in such a manner that the magnetic circuits have substantially equal minimum widths X, Y and Z.

The steps of a method of making a stator according to the invention with several magnetic poles provided in the same single general plane will be described below with reference to FIGS. 6a to 6d. The stator of a motor according to the method of the invention is formed from a plate 72 of magnetic material which cut out in a first step in such a way as to define the aperture 40 for passage of the rotor and several magnetic poles 8, 10, 26 and 28 defining this aperture 40. The magnetic poles are at this stage connected to one another and separated by blind slots 74, 75, 76 and 77. Thus the magnetic poles remain formed physically at this stage by a single flat part. The blind slots are arranged at the periphery of the aperture 40 and define more precisely the pole pieces of the provided magnetic poles.

It is noted that in a modification, one of the blind slots 74, 75 or 76 can be a through slot already at this stage. However, the shape of the part 72 shown in FIG. 6a is preferred. Since the part 72 is unitary, the aperture 40 can be machined very precisely. The magnetic poles 8, 10, 26 and 28 are located in the same general plane of the stator.

In a second step, an annular element 80 is applied to the cut out plate 72, in such a manner that it is centred relative to the aperture 40, as shown in FIG. 6b. The blind slots 74, 75 and 76 and the annular element 80 are arranged in such a way that this element fits over the slots 74, 75, 76 and 77, which extend beyond the external contour or periphery of the annular element 80. Thus, this element 80 covers at least partially the magnetic poles 8, 10, 26 and 28. The element 10 is preferably made from a non-magnetic material but in a modification the use of a weakly magnetic material compared with the stator is envisaged, so as to limit the stray magnetic fluxes. In particular the annular element is formed from a metal which is non-magnetic or weakly magnetic. The element 10 is of stainless steel for example.

Next the annular element 80 is fixed to the magnetic poles, as shown in FIG. 6b. The fixing of the annular element 80 is preferably effected by laser welding. This allows the amount of energy applied to be controlled precisely, in order to avoid overheating the part 72, which could otherwise lead to structural modification of the plate 72 and thus of its magnetic properties in the regions of the pole pieces In the case in which the annular element is formed of a metal such as stainless steel for example, the welding can be effected through the element 80 in the regions 82 to 85. To effect this the laser beam employed is directed on to the upper face of the annular element relative to the stator still defined at this stage by the plate 72.

Finally, as shown in FIG. 6d, the plate 72 is cut in such a manner as to extend the slots 74, 75 and 76 and thus obtain through slots 74a, 75a and 76a. Accordingly the principal magnetic poles 8, 10 and 12 are magnetically separated. In a more general manner the method is employed whenever it is desired to separate at least one of the magnetic poles from the other poles of the stator. The stator 2 thus obtained corresponds to the second embodiment of a motor according to the invention shown in FIG. 5. The last stage of cutting does not affect the positioning of the magnetic poles, these being maintained rigidly in position by the ring or collar 80. Furthermore this ring stiffens the stator in the region of the aperture 40 provided for the permanent magnet of the rotor.

Other means of fixing the ring 80 to the part 72 can be provided, in particular by electric welding or even by an adhesive. However laser welding is the preferred variant in particular for the reason mentioned above.

1-10. (canceled)

11. A two phase motor of small size comprising:
a stator carrying two power supply windings; and
a rotor provided with a bipolar permanent magnet, wherein the stator defines a first principal magnetic pole, a second principal magnetic pole and a third principal magnetic pole that together define a stator aperture in which the bipolar magnet is housed, and the first and second principal poles are connected to the third principal pole by two magnetic cores, respectively, each core carrying one of the two windings, wherein the third principal pole defines two adjacent secondary poles separated in a peripheral region at the stator aperture by a region of high magnetic reluctance and connected to one another by a stator part of high magnetic permeability, wherein the first and second principal poles and the two secondary poles are distributed in four sectors of a circle of about 90° around the stator aperture.

12. A two phase motor according to claim 11, wherein the region of high magnetic reluctance separating the two secondary poles is defined by a blind slot opening into the stator aperture.

13. A two phase motor according to claim 11, wherein the three principal magnetic poles are formed by three planar parts that extend in the same general plane.

14. A two phase motor according to claim 12, wherein the three principal magnetic poles are formed by three planar parts that extend in the same general plane.

15. A two phase motor according to claim 11, wherein the stator is formed of an iron-silicon alloy.

16. A two phase motor according to claim 12, wherein the three principal magnetic poles are formed by three planar parts that extend in the same general plane.

17. An indicator device of the value of a measured physical magnitude in a moving automobile vehicle, the device having an analog display and comprising a motor according to claim 11 for driving the analog display.

18. A method of making a motor of small size having a stator with several magnetic poles around an aperture provided for the permanent magnet rotor, the method comprising the following successive steps:
(a) cutting out a plate formed of a magnetic material so as to define the aperture for the rotor and the several magnetic poles that extend in the same general plane, these poles defining pole pieces separated by slots in the peripheral region of the aperture, at least a part of the slots are blind so that the magnetic poles remain formed physically as a single part at this stage;
(b) applying an annular element to the cut out plate in a manner centered relative to the aperture, wherein the slots and this annular element are arranged so that the annular element passes over the slots and the slots extend beyond an external contour of the annular element, wherein the annular element is at least partially covering the several magnetic poles and is formed of a non-magnetic or weakly magnetic material relative to the plate of magnetic material;
(c) fixing the annular element to the several magnetic poles; and
(d) cutting the plate in such a manner as to extend at least two of the blind slots to obtain through slots magnetically separating at least one of the magnetic poles from the other poles of the stator thus formed.

19. The method according to claim 18, wherein fixing of the annular element is effected by laser welding.

20. The method according to claim 19, wherein welding is effected through the annular element, the laser beam being directed on to an upper face of the annular element relative to the plate.

21. The method according to claim 19, wherein the said annular element is made of a non-magnetic or weakly magnetic metal.

22. The method according to claim 21, wherein the annular element is made of stainless steel.
